(19) United States
(12) Patent Application Publication
(10) Pub. No.: US 2012/0089055 A1
(43) Pub. Date: Apr. 12, 2012

(54) PATIENT TAPE FORCE PAD

(76) Inventor: Helge Fossan, Stavanger (NO)

(21) Appl. No.: 13/220,899

(22) Filed: Aug. 30, 2011

(30) Foreign Application Priority Data
Oct. 7, 2010 (NO) 2010 1388

(51) Int. Cl. A61H 31/00

(52) U.S. Cl. 601/41

(57) ABSTRACT

A CPR device for aiding a user in the performance of chest compressions, which is adapted to be placed on the chest of a patient and has means for measuring the compression force applied. The device has an electrically conductive means (5, 6) forming a first part of a capacitor, wherein a second part of said capacitor comprises an electrically conductive material (11) in a tape (15) adapted to be placed between the device and the patient, said tape (15) also having a compressible layer (10) between the electrically conductive material (11) and the device, and a capacitance measuring means (20) for measuring changes in the capacitance of the capacitor when the compressible layer (10) is compressed during chest compressions.

### TECHNICAL FIELD

The present invention relates to a device for measuring compression force when performing chest compressions during CPR (Cardio Pulmonary Restitution) according to the preamble of the enclosed claim 1.

### BACKGROUND ART

When performing chest compressions during CPR an important factor for efficient chest compression is the depth of the compressions. The depth is in turn depending on the force used to compress the chest.

Ideally, the compression depth should be measured directly. However, this has proven to be very difficult to do. The use of an accelerometer can also give an indication of the compression depth, but since the compressibility of the chest varies a lot from patient to patient, the results are still approximate. Moreover, if the patient is in a bed, the bed will also cushion with the compression.

A simple way of obtaining an indication of the compression depth is to measure the force and assume that the compression depth is proportional to the force. However, the force alone will also only give an approximate indication of the compression depth, and the accuracy is very dependent on the quality of the force sensor. Moreover, the compressibility of a human chest vary substantially; meaning that for a force sensor to be able to give an indication of compression depth, the compressibility of the chest has to be known. Calibration of the force sensor to an individual chest takes inevitably some time, which can be a crucial loss of time in a life saving situation.

Various prior art devices have been developed, such as those described in US 2007/0010764, which describes the use of an accelerometer, US 2008/00171311, which can use an accelerometer, position sensor or a pressure sensor to indirectly measure the compression depth. The compression depth is achieved by double integration of the acceleration measured.

WO 2004/056303, belonging to the present applicant also describes a device for monitoring the compression depth indirectly by measuring the force applied.

The present applicant also markets a device called CPRmeter™, which measures both force and acceleration to obtain an indirect indication of compression depth.

Another device on the market is CPR-Ezy™, which measures the force used during compressions. This device gives a visual indication of the compression depth.

Numerous other devices for indirectly obtaining an indication of compression depth are known from U.S. Pat. No. 4,554,910, U.S. Pat. No. 4,863,385, U.S. Pat. No. 5,496,257 and U.S. Pat. No. 6,013,041.

All these devices have in common that they are fairly complicated, bulky and relatively heavy.

US 2008/0312565 shows a very thin and simple device containing sensors for measuring depth, force or acceleration.

A further challenge when using a device of this type to aid the user in performing correct chest compressions is that the device must be placed within a specific area on the chest of the person. The desired area is the lower part of the sternum. During the course of the CPR the device may relocate from this area, and if it moves away from the desired area, the user may have to move it back again from time to time. It is therefore not uncommon to use a double sided tape on the side of the device facing the person to be resuscitated. This will usually hold the device in place in a sufficient degree during the CPR.

### SUMMARY OF INVENTION

The present invention aims to simplify the chest compression aiding device and also enhance the use of a patient tape to hold the device in position against the chest of a person.

This is achieved by a device including a tape that has a compressible layer and a layer including an electrically conductive material. The electrically conductive layer interacts with at least one electrically conductive means on the device to form at least one capacitor.

When a force is applied on the device, the compressible layer will be compressed, which in turn brings the electrically conductive means in the device closer to the electrically conductive material. This alters the capacitance of the capacitor. This change in capacitance can be measured and gives an indication of the force applied on the device.

The present invention also has as one of its objectives to enhance the accuracy of the determination of the chest compression depth by using a force sensor according to the invention to improve the integration of the acceleration measurements.

According to one embodiment of the invention, the force sensor is used to determine when actual compression is taking place and hence when integration of the acceleration measurement is to be done; i.e. at which point to start the integration and at which point to stop the integration.

It is important to release the compression at least nearly completely between each compression. If this is not done, the patient chest will not expand to full extent; meaning that the heart will only be partially filled with blood when the next compression starts. In order to ensure this the force sensor of the invention will, according to a further embodiment of the invention, be used to determine if the compression force has been released.

### BRIEF DESCRIPTION OF DRAWINGS

The invention will now be described further, referring to exemplary embodiments illustrated in the appended drawings, wherein:

FIG. 1 shows schematically a device according to the present invention, including a patient tape according to the present invention.

FIG. 2 shows schematically a patient tape according to the present invention.

FIG. 3 shows a block diagram of the electrical connections.

### DETAILED DESCRIPTION OF THE INVENTION

When in the following description terms like top side, underside etc. are used, these denote the devices described in its orientation when they are used for chest compression, i.e., when the patient is lying flat on his back in a generally horizontal position.

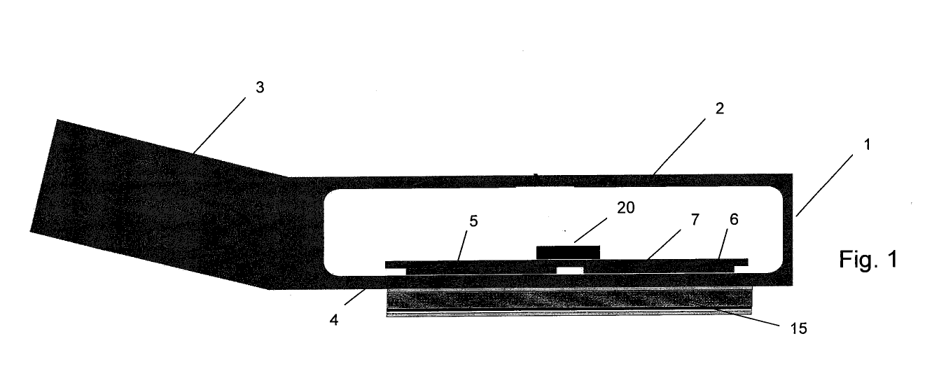

FIG. 1 shows an aiding device for assisting the user when performing chest compressions. It comprises a body 1 having a top surface 2 against which the user presses with his hands during use. It also comprises an inclined display surface 3 for displaying information relating to the chest compression efficiency. The device may also have a sound generator (nor shown) that provides audible feedback to the user, like a beep every time when the force of the chest compression is sufficient, and a click for each time a chest compression is due.

The body also has an underside 4, which is to face the chest of a patient.

Inside the body, the device has two electrodes 5, 6, made of a suitable electrically conductive material, preferably copper. The electrode 5, 6 are placed on the inside of the body wall forming the underside 4 at some distance apart.

An insulator 7, which preferably also has the function of a printed circuit board (PCB) is placed on top of the electrodes 5, 6, completely covering both electrodes 5, 6.

On the PCB 7 a capacitance measurement device 20, preferably an integrated circuit (IC) is placed.

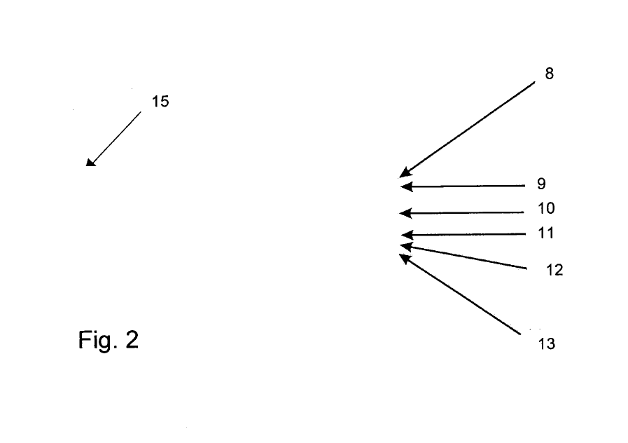

On the underside surface 4 a patient tape 15 is affixed. The patient tape is shown in detail in FIG. 2. It comprises several layers, which from the top in FIG. 2 are: A first liner 8, a first adhesive layer 9, a compressible material 10, an electrically conductive layer 11, a second adhesive layer 12 and a second liner 13.

The two liners 8 and 13 serve to protect a respective one of the adhesive layers 9 and 12. The liner 8 is peeled off to affix the patient tape to the underside 4 of the chest compression aiding device. The liner 13 is peeled off when the device is to be placed on the chest of the patient. The adhesive layer 12 is preferably of a type that adheres well to human skin, but also can be removed without too much effort. Preferably the same adhesive is used for both adhesive layers 9 and 12.

The compressible material 10 is preferably foam that has a compression coefficient proportional with the force applied; preferably the compression/force relationship is linear. Its thickness is sufficient to not reach a full compression until the required force for sufficient chest compression is applied. Preferably, it is possible to compress the foam somewhat beyond the required force. The foam is preferably a dielectric material.

The electrically conductive layer 11 is preferably a Biaxially-oriented polyethylene terephthalate (boPET), also marketed as Mylar®, with a metal film. Alternatively it may be a metal grid.

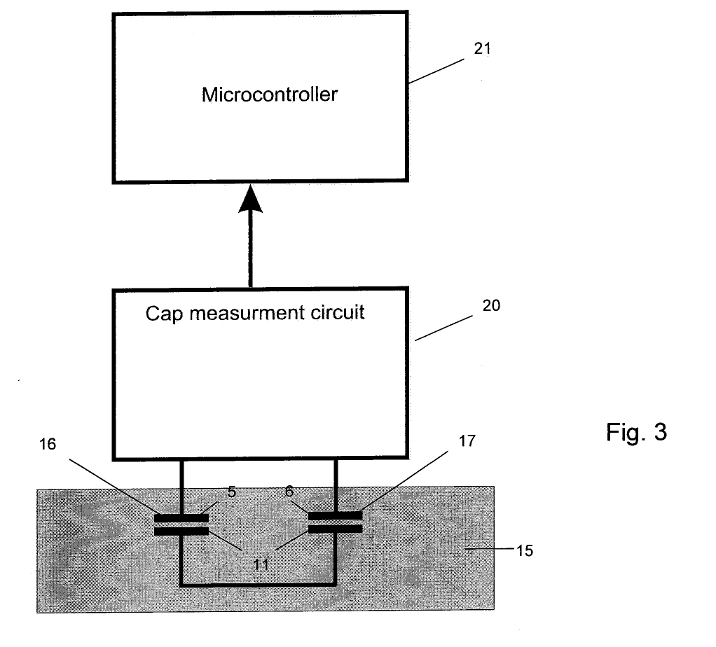

When the patient tape 15 is affixed to the underside 4 of the chest compression aiding device, the electrically conductive layer 11 form two capacitors with the electrodes 5, 6 inside the body 1, as illustrated schematically in FIG. 3.

FIG. 3 schematically illustrates the patient tape 15. Two capacitors 16 and 17 are formed by the electrically conductive layer 11 and the electrodes 5, 6, by the electrically conductive layer 11 forming one conductor of both capacitors and the electrodes 4, 5 forming the conductor of a respective capacitor 16, 17. A small AC current is applied to the capacitors by the capacitance measurement device 20.

When the device is placed on the chest of a patient with the tape 15 against the patient's skin, the capacitance of the capacitors 16, 17 can be altered by pressing the aiding device against the chest of the patient. This will compress the compressive layer 10 and reduce the distance between the conductors of the capacitors 16, 17. The reduced distance results in an increase of the capacitance of the capacitors 16, 17.

The capacitance measuring device 20 continuously monitors the capacitance by measuring the AC current or by a charge/discharge methodology. Since the relationship between the compression of the foam and the force applied is known and the only variable factor influencing on the capacitance is the distance between the conductors, the capacitance is a direct expression of the force applied during chest compression. A microcontroller 21 calculates the compression force from the capacitance measured, and if the compression force is above a desired value, gives a signal to the user that he has obtained a sufficient force. The user can then release the pressure and prepare for the next compression.

When the CPR is finished, the tape can be peeled off and disposed with. The next CPR will commence with a fresh piece of tape. Thereby the user will always have fresh adhesive that will stick to the skin of the patient. Since the foam is also fresh for each CPR, long term changes of compression characteristics for the foam is of no consequence.

As soon as the patient tape is affixed to the aiding device and the device is turned on, it will start a short calibration procedure and determine the capacitance of the capacitors 16, 17 when the foam 10 is uncompressed, i.e., no force is applied.

In an alternative embodiment, the body 1 contains only one electrode that forms one capacitor with the electrically conductive layer in the tape. In order to form a complete circuit, the electrically conductive layer must have electrical contact with the capacitance measurement device 20. This can be achieved by a small strip of metal film extending beyond the edge of the rest of the layers of the tape. The strip can be pressed against a contact on the underside of the aiding device. Preferably, the strip of film has an electrically conductive adhesive that will glue the strip of film to the contact.

The CPR device preferably also comprises an accelerometer for measuring the acceleration of the device during compressions. By double integration of the acceleration measurement the compression depth can be determined. The compression force sensor can be used to set the point at which the integration should start and stop, i.e. when the compression force has reached a predetermined level, an average level at which the chest begins to compress, the integration of the acceleration starts. When the user lifts his hands again to let the chest expand the force is reduced again and when it goes below a certain value the integration of the acceleration will end. The resulting double integration will therefore be made from the point at which the chest begins to compress until the point at which the chest is fully compressed and the expansion commences.

By this method a higher accuracy of the depth calculations will be achieved.

The force sensor is also preferably used to control that the user completely, or close to completely, relaxes his pressure when the chest has reached its full expansion and before the next compression starts. If the user does not let the chest expand fully, the heart may not be filled with blood to the full extent. The result would be that only a fraction of the full capacity of blood will be pressed out from the heart at each compression. This may in a significant degree reduce the efficiency of the heart compression.

If the compression force is not reduced below a certain set value before it increases again, i.e. before the next compression, the CPR device may give off an audible signal to the user indicating that he should let the chest expand more before the next compression.

1. A CPR device for aiding a user in the performance of chest compressions, said device being adapted to be placed on the chest of a patient, and having a means for measuring the compression force applied and a means for communicating information on the efficiency of the chest compression to a user, the device having an electrically conductive means forming a first part of a capacitor, wherein a second part of said capacitor comprises an electrically conductive material in a tape adapted to be placed between the device and the patient, said tape also having a compressible layer between the electrically conductive material and the device, and a capacitance measuring means for measuring changes in the capacitance of the capacitor when the compressible layer is compressed during chest compressions.

2. A CPR device according to claim 1, wherein the CPR device has two electrodes forming a first part of a respective one of two capacitors.

3. A CPR device according to claim 2, wherein said electrically conductive material in said tape forming the second parts of said two capacitors.

4. A CPR device according to claim 1, wherein said electrically conductive layer in said tape has a contact area facing the CPR device and being adapted to form electric contact with a contact area on the CPR device to form an electric circuit comprising the first and second part of the capacitor.

5. A CPR device according to claim 1, wherein said tape has a first adhesive layer for attaching the tape to the CPR device.

6. A CPR device according claim 1, wherein said tape has a second adhesive layer for attaching the tape to a patient chest.

7. A CPR device according to claim 1, further comprising an accelerometer, said accelerometer and said force measuring means being adapted to interact to determine a compression depth of said chest compressions.

8. A CPR device according to claim 7, wherein said force measuring means determine between which points a double integration of the measured acceleration is done.

9. A CPR device according to claim 7, further comprising a means for detecting if the compression force has been relaxed between each compression, wherein said means for communication with the user is adapted to communicate the result of the detection to the user.

10. Tape for use with a CPR device that is adapted to be placed on the chest of a patient for aiding a user in the performance of chest compressions, the tape comprising an electrically conductive material and a compressible layer, said electrically conductive material constituting one part of a capacitor, the second part of said capacitor being in said CPR device, said compressible layer being adapted to be compressed when chest compressions are performed, thereby altering the capacitance of said capacitor.

11. Tape according to claim 10, wherein said tape has a first adhesive layer for attaching the tape to a patient chest.

12. Tape according to claim 10, wherein said tape has a first adhesive layer for attaching the tape to the CPR device.

13. Tape according to claim 10, wherein said electrically conductive layer has a contact area facing the CPR device and being adapted to form electric contact with a contact area on the CPR device to form an electric circuit comprising the first and second part of the capacitor.
